(19) United States
(12) Patent Application Publication
(10) Pub. No.: US 2024/0151688 A1
(43) Pub. Date: May 9, 2024

(54) EDDY CURRENT TESTING APPARATUS AND RELATED METHODS

(71) Applicant: Holtec International, Camden, NJ (US)

(72) Inventor: Brian Farnsworth, East Liverpool, OH (US)

(21) Appl. No.: 18/386,899

(22) Filed: Nov. 3, 2023

Related U.S. Application Data
(60) Provisional application No. 63/422,174, filed on Nov. 3, 2022.

(51) Int. Cl. G01N 27/90; G01N 27/9013; G01N 27/9093

(52) U.S. Cl. CPC G01N 27/9006; G01N 27/902; G01N 27/9093

(57) ABSTRACT

An eddy current testing apparatus and related methods for conducting non-destructive examination of heat exchanger tubes accessible via a heat exchanger tubesheet. The apparatus comprises a motor-driven drive pulley and one or more idler pulleys engageable with the test cable of the test probe to feed out or retract the cable and test head which are insertable into the heat exchanger tube under test. A support bracket of the apparatus includes manually-expandable tube clamps operated by an actuating lever. The clamps include a tubular securement sleeve with expandable portion for insertion into and releasably locking to an anchoring tube in tubesheet. This supports the apparatus from the tubesheet in a cantilevered manner. The idler pulley(s) may be mounted to a pivot arm movable between an inward position to press the cable into engagement with the drive pulley, and an outward position which releases the cable to facilitate setup or takedown.

### CROSS-REFERENCE TO RELATED APPLICATIONS

This application claims the benefit of U.S. Provisional Application No. 63/422,174 filed Nov. 3, 2022, which is incorporated herein by reference in its entirety.

### BACKGROUND

The present invention relates generally to testing metallic materials for defects, and more particularly to an improved eddy current testing apparatus and related methods suitable for testing circular conduits such as heat exchanger tubes.

With the increasing demand for the world's power grids, now more than ever, it is important to keep power plant condensers, feedwater heaters and other balance of plant heat exchangers running at peak efficiency. While it is well known that keeping these units clean is important for maximizing power output, so too is monitoring each unit's tube integrity, and taking corrective action to prevent tube failure including identifying incipient defects leading to imminent tube leaks. One way to monitor a heat exchanger unit's tube integrity, detect patterns of tube wear and damage caused by both tube-side and shell-side fluid flow, and determine the specific wear and damage to a particular tube is through Non-Destructive Testing (NDE). Depending on the tube material, the NDE options include eddy current testing, remote field testing, or other variations of these electromagnetic examination techniques.

Eddy current testing measures electromagnetic fields generated in metal structures such as heat exchanger tubes by the eddy current testing unit to identify deformities or defects such as for example cracks, thinning tube wall thickness evidencing erosive wear caused by tube-side and/or shell-side fluid flow, or other damage. The testing unit can also measure physical properties of the tube structure or workpiece such as metal wall thicknesses, hardness, conductivity, and others.

Eddy current testing of heat exchanger tubes generally involves accessing open tube ends through the thick tubesheet of heat exchanger. The tubes penetrate the tubesheet and are tightly packed typically in an offset tube pitch arrangement. The test probe, comprising a test head and associated length of power/control cable coupled thereto, are generally hand-inserted into and manually fed and advanced through the entire length of the tubes under test, which can often be 30 feet or longer in typical feedwater heaters (heat exchangers) used in power generation plants. Hundreds and well over 1,000 tubes may be encountered in a tube bundle of a typical power plant low or high pressure feedwater heater. This is generally a two operator setup with one technician manually inserting the test probe slowly through the tube and a second technician observing the electronic monitor/screen of the test unit to read the signals generated by the probe to identify potential tube defects. Accordingly, such eddy current tube testing is a lengthy and cumbersome process and not amenable to testing multiple tubes simultaneously in parallel.

Improvements in eddy current testing are desired.

### BRIEF SUMMARY

The present disclosure provides an eddy current testing apparatus and related methods which overcomes the deficits of purely manual heat exchanger tube testing. The testing apparatus is configured and operable for detachable coupling to the heat exchanger sheet to access the tubes desired for eddy current testing. The setup and takedown of the apparatus is manual. However, performance of the eddy current testing may be automatically controlled by a servo motor-powered cable drive system operably coupled to a programmable controller. The drive system includes a drive pulley coupled to the motor and one or more idler pulleys which operably engage the test cable of the eddy current test probe to feed out or retract the cable and attached test head automatically via the controller. In other embodiments, the motor may be manually controlled to feed or retract the cable. The test head and cable are inserted into and gradually advanced along the length of the heat exchanger tube under test while the controller receives and measures changes in voltage or impedance of the test coil in the test head to detect tube defects. The controller may include a visual display which can be observed by a single test equipment operator or technician. Accordingly, a single test equipment operator or technician can conduct eddy current tube testing including setup of the testing apparatus and monitoring electrical readings communicated to the controller by the test head since the controller is programmed to operate the motor to control feeding the test head and cable through the length of the heat exchanger tube under test; not manually as in past testing approaches. In some equipment setups, multiple heat exchanger tubes can be tested in parallel by using several eddy current testing apparatuses all operably coupled to the controller.

The servo motor in some embodiments may be a stepper motor coupled with an encoder. The stepper motor can gradually feed and advance the test head and cable through the tube under test in an incremental stepped or indexed manner. The stepper motor and encoder combination allows the precise location of defects or abnormalities in the heat exchanger tube to be identified for potential corrective measures.

An eddy current testing apparatus according to the present disclosure in one embodiment includes a support bracket including a pair of manually-expandable tube clamps configured for detachable anchoring in heat exchanger tubes accessible through the tubesheet which are not under test. The tube clamps support the apparatus in a cantilevered manner from the tubesheet. Each tube clamp includes an actuating lever comprising a cam head at one end configured to produce a camming action which radially expands and enlarges an expandable portion of the clamp to frictionally engage the inside surface of a respective anchoring tube. The expandable portion may be formed by a slotted end of a securement sleeve coupled to a face plate of the bracket. The actuating levers are each pivotably movable between a locked position and unlocked position to engage or disengage the tube clamp from the anchoring tubes, respectively.

A tapered alignment ferrule disposed on the bracket abuttingly engages the tube under test to feed and center the test head and cable in the tube. This also facilitates both setup of the testing apparatus and feeding the cable smoothly into and out of the tube during eddy current testing. Multiple alignment ferrules be provided with central through passages of different diameters. The alignment ferrules can be interchangeably mounted on the testing apparatus bracket to accommodate test heads and associated cables of different diameters to test heat exchanger tubes of different diameters. This provides a module testing system.

The eddy current testing apparatus in preferred embodiments further includes a pivotably movable pivot arm which in one aspect facilitates manually threading the test head and cable through the alignment ferrule and into the tube under test to begin testing, and then withdrawing the head and cable therefrom. The pivot arm is coupled to the testing apparatus bracket about a pivot axis. The one ore more idler pulleys are rotatably mounted to the arm. The pivot arm is pivotably movable between an inward engaged position in which the one or more idler pulleys press the test cable into engagement with drive pulley to maintain positive contact therebetween during cable feed or retrieval, and an outward disengaged position in which the one or more idler pulleys are distally located with respect to drive pulley. The outward position is used to initially thread the test head and cable through the apparatus into the tube under test, and then again to withdraw the cable after testing is complete. In one embodiment, preferably two idler pulleys are provided and arrangement so that the cable makes about 90 degrees of contact with the drive pulley to ensure smooth feeding/retraction of the cable via operation of the motor in a precision controlled manner. A return spring biases the pivot arm towards the inward engaged position to keep the test cable engaged with the drive pulley.

According to one aspect, an eddy current testing apparatus comprises: a bracket configured for detachable coupling to a tubesheet of a heat exchanger; a rotatable drive pulley operably coupled to a motor supported by the bracket; a pivot arm coupled to the bracket and pivotably movable about a pivot axis, the idler pulley comprising a first idler pulley; an eddy current test probe comprising a test head and cable, the cable routed between and engageable with the first idler pulley and the drive pulley; the first idler pulley operable to press the test cable against the drive pulley to maintain engagement therebetween; wherein rotating the drive pulley in a first rotational direction feeds out cable from the apparatus, and rotating the drive pulley in a second rotational direction retracts cable back to the apparatus.

According to another aspect, a method for performing eddy current testing of heat exchanger tubes comprises: providing an eddy current testing apparatus including a bracket comprising a pair of tube clamps, each tube clamp comprising a radially expandable portion operably coupled to a pivotably movable actuating lever configured to actuate the expandable portion, the actuating lever of each tube clamp being in an unlocked position; positioning the bracket adjacent to a tubesheet of a heat exchanger comprising a plurality of heat exchanger tubes coupled to the tubesheet; inserting the expandable portion of each tube clamp into a respective anchoring heat exchanger tube accessible via the tubesheet; rotating the actuating levers of each tube clamp to a locked position; and radially expanding the expandable portion of each tube clamp to frictionally engage the respective anchoring heat exchanger tubes; wherein the testing apparatus is supported from the tubesheet in a cantilevered manner.

### BRIEF DESCRIPTION OF THE DRAWINGS

The present invention will become more fully understood from the detailed description and the accompanying drawings, wherein like elements are labeled similarly and in which:

FIG. 1 is a first front perspective view of an eddy current testing apparatus according to the present disclosure;

FIG. 2 is a second front perspective view thereof;

FIG. 3 is a rear perspective view thereof;

FIG. 4 is a front view thereof;

FIG. 5 is a rear view thereof;

FIG. 6 is a first lateral side view thereof;

FIG. 7 is a second lateral side view thereof;

FIG. 8 is a top view thereof;

FIG. 9 is a bottom view thereof;

FIG. 10 is a cross sectional view of the testing apparatus taken through the alignment ferrule on the face plate of the support bracket;

FIG. 11A shows the eddy current testing apparatus with the pivot arm in a displaced outward position disengaging the test head and cable of the test probe for setting up or taking down the testing apparatus;

FIG. 11B shows the eddy current testing apparatus with the pivot arm in an inward position engaging the test cable which is pressed against the drive pulley for testing a heat exchanger tube under test;

FIG. 12 is a perspective of the tube clamp assembly of the apparatus in isolation;

FIG. 13 is a first exploded perspective view thereof;

FIG. 14 is a second exploded perspective view thereof;

FIG. 15 shows the actuating lever of the tube clamp assembly in a locked position;

FIG. 16 shows the actuating lever of the tube clamp assembly in an unlocked position;

FIG. 17 is a schematic drawing comprising a side cross-sectional view taken through a representative shell and tube heat exchanger usable with the testing apparatus showing the tubesheet and heat exchanger tube penetrations therethrough; and

FIG. 18 is a front perspective view of the heat exchanger tube sheet showing a plurality of detachably mounted eddy current testing apparatuses in operation at once to conduct eddy current testing of the heat exchanger tubes in parallel.

All drawings are schematic and not necessarily to scale. Features shown numbered in certain figures which may appear un-numbered in other figures are the same features unless noted otherwise herein.

### DETAILED DESCRIPTION

The features and benefits of the invention are illustrated and described herein by reference to non-limiting exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

As may be used herein, the terms “seal weld or seal welding” shall be construed according to its conventional meaning in the art to be a continuous weld which forms a gas-tight joint between the parts joined by the weld.

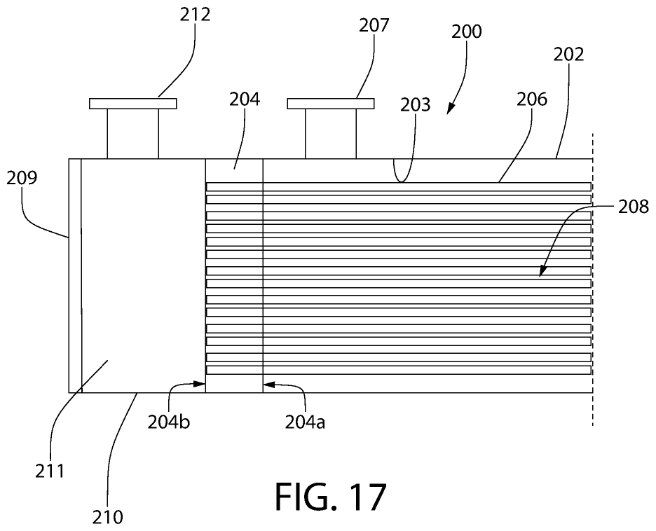

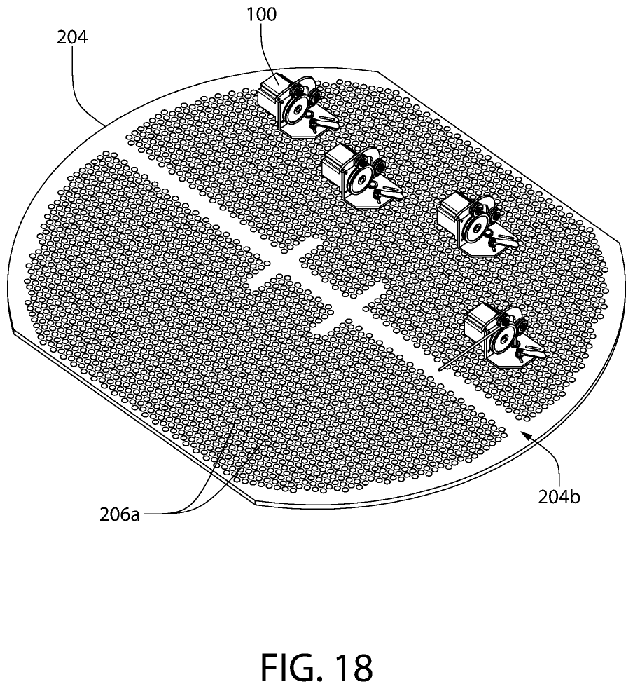

FIGS. 17 and 18 depict a typical shell and tube type heat exchanger 200 whose heat exchanger tubes 206 can be tested via the eddy current testing apparatus 100 disclosed herein. The heat exchanger generally includes an elongated cylindrical shell 202 defining an internal cavity 203 which holds a tube bundle 208 comprising a plurality of heat exchanger tubes 206. The tube bundle may be a straight tube design or U-tube design. The tubes are coupled at least at one end to a thick metal tubesheet 204 having an inside face or surface 204a facing inwards towards cavity 203 and an outside face or surface 204b. Tubesheet 204 is oriented perpendicularly to the length of the elongated shell. The tubesheet shown is vertically oriented as the shells of these type heat exchangers (i.e. shell and tube) are generally horizontally oriented and located on a flat horizontal support surface; however, other orientations of the heat exchanger and tubesheets may be encountered for testing (e.g., vertical shells and tubes with horizontal tubesheets) which can all be accommodated by the eddy current testing apparatus disclosed herein.

The open ends 206a of each heat exchanger tube 206 in the bundle extend through penetrations in the tubesheet 204 from the inside surface 204a and are terminated at the outside surface 204b of the tubesheet. The tube ends may be rigidly affixed at the penetrations through the tubesheet via any suitable method commonly used in the art, including for example without limitation explosive, mechanical or hydraulic expansion, welding, or other techniques and combinations thereof. The open ends 206a of the tubes 206 are therefore accessible for eddy current testing from the outside surface 204b of tubesheet 204 by the testing equipment operator. The tubesheet is generally accessible via the heat exchanger head or channel 210 which typically has a removable bolted or welded closure plate 209 (depending on the operating pressure of the heat exchanger). The channel 210 defines an internal flow plenum 211 for the tube-side fluid whereas the cavity 203 of the shell defines the shell-side flow pathway. A tube-side fluid connection 212 is coupled to channel and fluidly communicates with plenum 211 for either introducing or discharging the tube-side fluid into/from the heat exchanger depending on the flow and physical arrangement of the heat exchanger provided (there being several design options for shell and tube heat exchangers in the art). A shell-side fluid inlet connection 207 coupled to the shell 202 is shown for introducing the shell-side fluid into the heat exchanger. A shell-side fluid outlet connection would also be provided (not shown) at the opposite end of the shell for discharging the shell-side fluid. Shell and tube heat exchanger designs and variations are well known in the art without further undue elaboration being necessary here.

The present eddy current testing apparatus 100 may be used to test tubes 206 of either straight or U-bend configuration so long as an open end 206a of each tube is accessible via the tubesheet 204. The present eddy current testing apparatus may also be used to test tubes 206 arranged in any pitch pattern in the tubesheet 204. Staggered tube patterns shown in FIG. 18 are commonly used to pack as many tubes in the tube bundle as possible. This conserves space and reduces the diameter of the shell and concomitantly the tubesheet required for a given heat transfer load (also influenced by the thermal conductivity of the type of metal tubes selected for the heat exchanger).

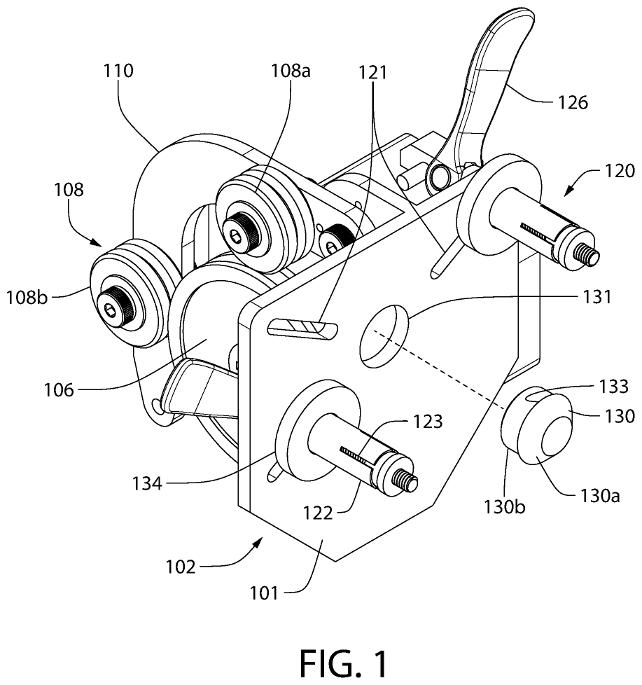

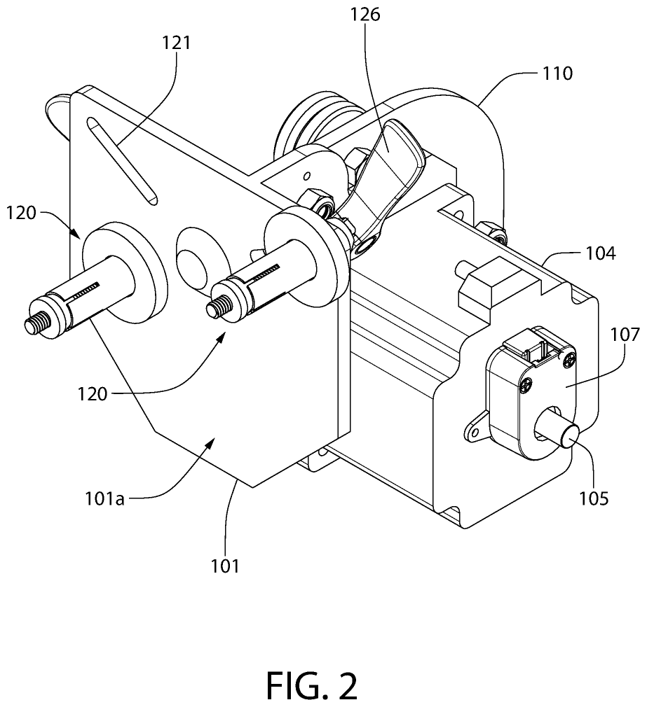

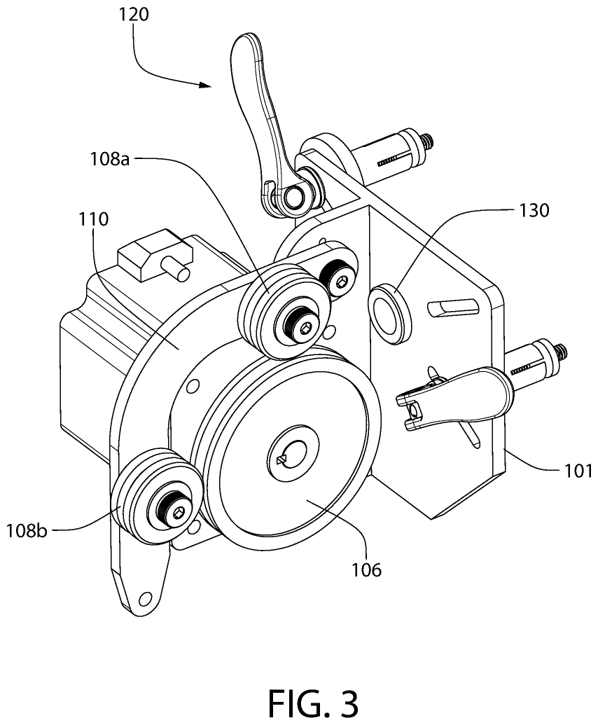

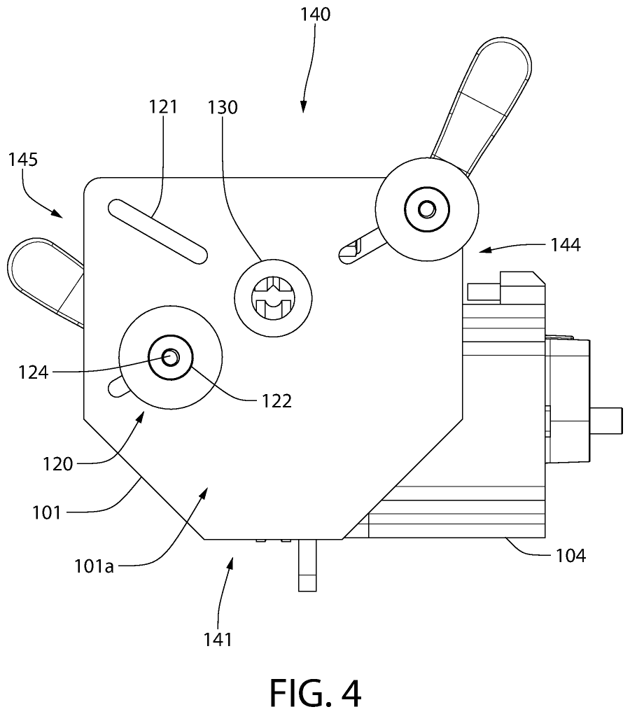

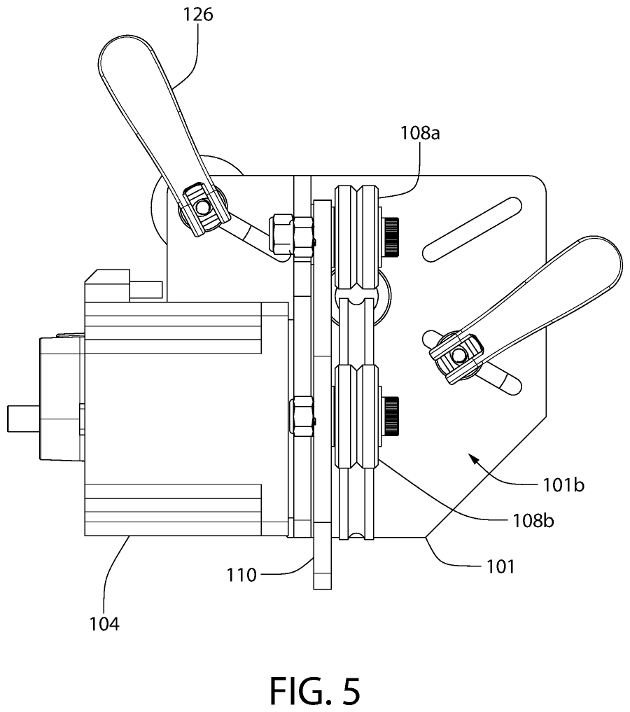

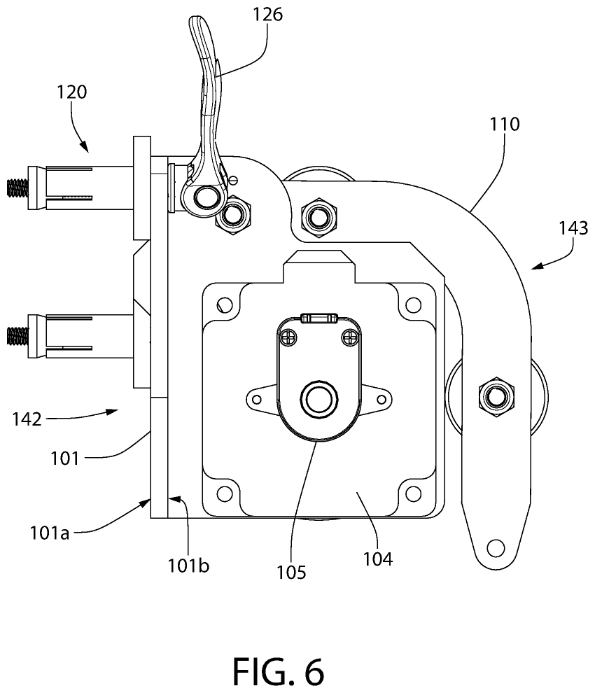

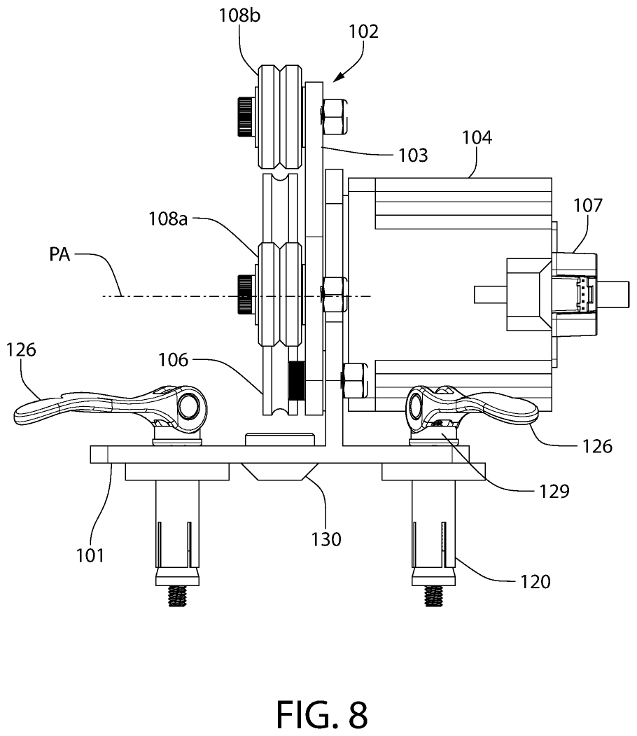

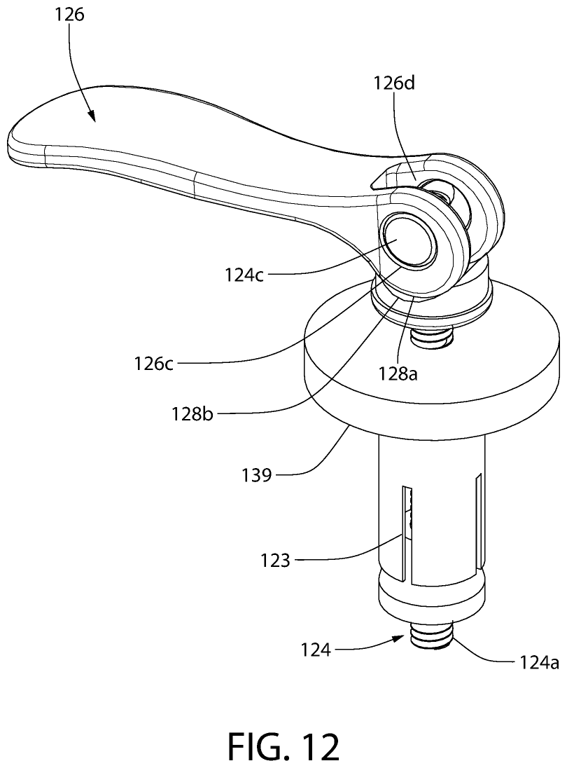

FIGS. 1-16 depict one non-limiting embodiment of the eddy current testing apparatus 100 and features thereof according to the present disclosure. The figures generally illustrate the testing apparatus in the usual upright position (vertical) for testing heat exchangers which generally have vertically oriented tubesheets; however, other orientations of the apparatus may be used for tubesheets at other orientations. For convenience of reference and description, the testing apparatus in the depicted orientation defines a top 140, bottom 141, front 142 facing the heat exchanger tubesheet, rear 143 facing away from the tubesheet, and pair of lateral sides 144, 145.

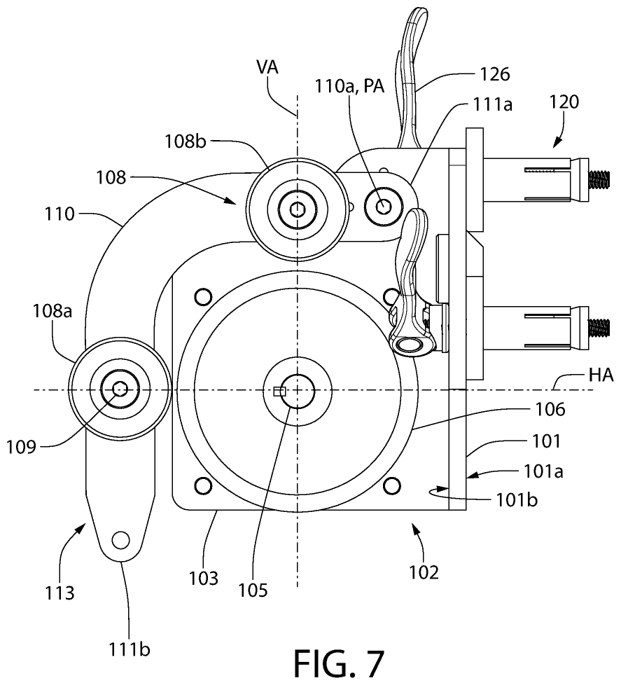

Eddy current testing apparatus 100 generally comprises components including a support bracket 102, a drive motor 104, drive pulley 106 operably coupled to the drive motor, pivot arm 110 including at least one idler pulley 108, and tube clamps 120 removably mounted to the bracket for detachably coupling the apparatus to the tubesheet comprising the heat exchanger tubes undergoing eddy current testing. For convenience of description and without limitation, reference axes may be defined including a horizontal axis HA and vertical axis VA both of which pass through and intersect at the geometric center of drive pulley 106 (see, e.g., FIG. 7).

Bracket 102 in one embodiment includes a face plate 102 and motor support plate 103 fixedly attached to the face plate. Motor 104 may be detachably mounted to the motor support plate by any suitable method such as via threaded fasteners. Face plate 102 may be flat in one embodiment and configured to be orientated parallel to the flat face or surface 204 of the tubesheet through which open ends 206a of tubes 206 of the tube bundle 208 extend and are accessible for eddy current testing, as previously described herein. Face plate 102 may be oriented perpendicularly to motor support plate 103 which may also be substantially flat in configuration. This forms a generally T-shaped structure or body of the bracket 102. Other configurations of brackets may be used as appropriate. The bracket may be formed preferably of metal such as steel or aluminum as non-limiting examples, or a suitably strong fiber reinforced plastic material. The choice of bracket material does not limit the invention in any manner.

Eddy current testing apparatus 100 further includes an eddy current test probe 150 which is an assembly comprising a test head 151 and test cable 152. Test head 151 is coupled to the one end of the test cable 152 and configured to form an electrical coupling between electrically-conductive wiring in the cable and the head for transmitting electric current and control signals therebetween for conducting the eddy current testing of the heat exchanger tubes. Test head 151 may be a “bobbin” type head having an elongated generally cylindrical configuration, which is typically used for eddy current inspection of heat exchanger tubes. The test head and attached cable are gradually feed through the length of the interior of the tubes for detection of flaws and defects such as cracks or thinning in the tube walls due to shell-side or tube-side erosion. Numerous commercially-available test head and cable assemblies used for conducting internal eddy current testing of tubes may be used with the present eddy current testing apparatus.

The basic working principle of the eddy current testing instrument is as follows. When the test coil contained in the test head 151 is energized with alternating current and positioned in the center of the heat exchanger tube under test, the alternating magnetic field generated by the coil will cause the tubing to generate current (eddy current). The size, phase and flow pattern of eddy current is affected by workpiece properties (conductivity, permeability, shape, size) and defects. The voltage and impedance of the coil are changed by the reaction of the magnetic field. Therefore, the change of voltage or impedance of the test coil can be measured by the test unit such as controller 250, and the nature, state and defect of the workpiece can be judged.

Motor 104 may be any commercially-available motor operable to rotate the drive pulley 106 in opposing rotational directions. Accordingly, motor 104 may be a reversible type motor which can rotate the motor drive shaft 105 coupled to drive pulley 106 in opposing directions for feeding test cable 152 out from apparatus 100 to advance the test head 151 in the heat exchanger tubes 206 in a first operating mode, and retracting the test cable back to retrieve the test head 151 in a second operating mode.

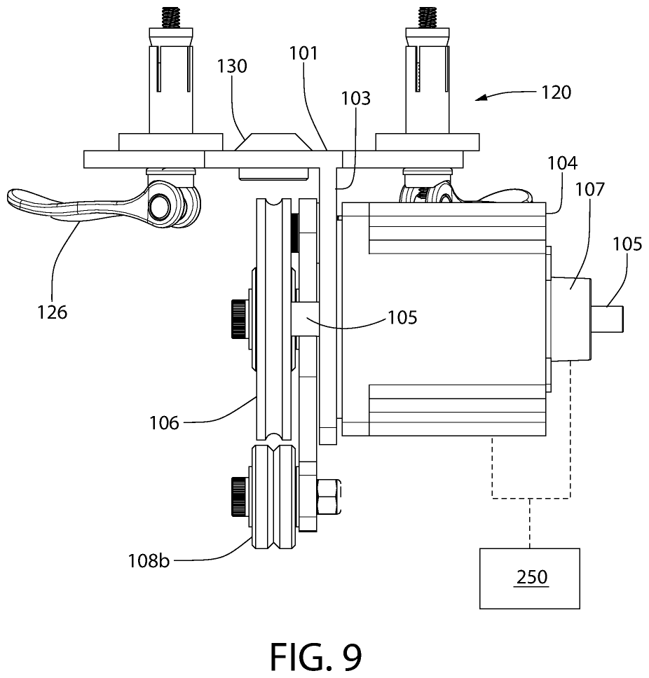

In one embodiment, motor 104 may be a servo stepper type motor which can provide incremental or indexed feeding and retraction of the test cable 152 with attached test head 151 in a precision manner through the interior of the heat exchanger tubes. As is well known in the art, a stepper motor is an electromagnetic apparatus which converts digital electrical pulses generated via the microprocessor of programmable controller 250 into indexed or “stepped” rotation of the motor shaft (i.e. small angular steps) as opposed to continuous motor shaft rotation provided by conventional motors. A dual shaft stepper motor with onboard encoder 107 can be used which measures the amount of rotation and angular position of the motor shaft 105, which can then be transmitted back to the controller 250. Using this information provided by the encoder, the controller is configured via programming to in turn determine the axial position of the eddy current test head 151 relative to the length of the heat exchanger tube so that the detection of anomalies in the tube wall can be pinpointed to a specific location in the tube. Dual shaft stepper motors comprise a single shaft 105 which has end portions protruding outwards from opposing sides of the motor housing (see, e.g., FIG. 9). One end is coupled to drive pulley 106 while the opposite end is coupled to the encoder 107.

The controller 250 may further be configured to automatically control the entire eddy current testing process of the tube 206 under test including operating the motor 104 to both feed the probe test head 151 and cable 152 into the tube under test in an indexed manner, and retract the test head and cable from the tube when the testing is completed. Conductive wiring in the cable operably and communicably links the controller 250 to the test head to allow the controller to receive test data signals back from the test head so that tube defects can be recorded in memory and pinpointed to an exact location in the tube. This allows action to be taken to remedy the defect such as welding and closing cracks where the tube bundle is accessible for repair to eliminate tube-side fluid leaks, or plugging an entire tube 206 by installing plugs in the defective tube at the tubesheet 204 for an in-service heat exchanger where the tubes might not be accessible for repair without extracting the tube bundle 208 from the heat exchanger shell, or where tube repairs are impractical.

Controller 250 may be any suitable commercially-available controller with programmable processor provided with the usual associated electronic appurtenances and devices necessary to provide a fully functional and user-configurable controller. As one non-limiting example, the controller may be a computer (e.g., laptop or other programmable device) running software to control the eddy current testing.

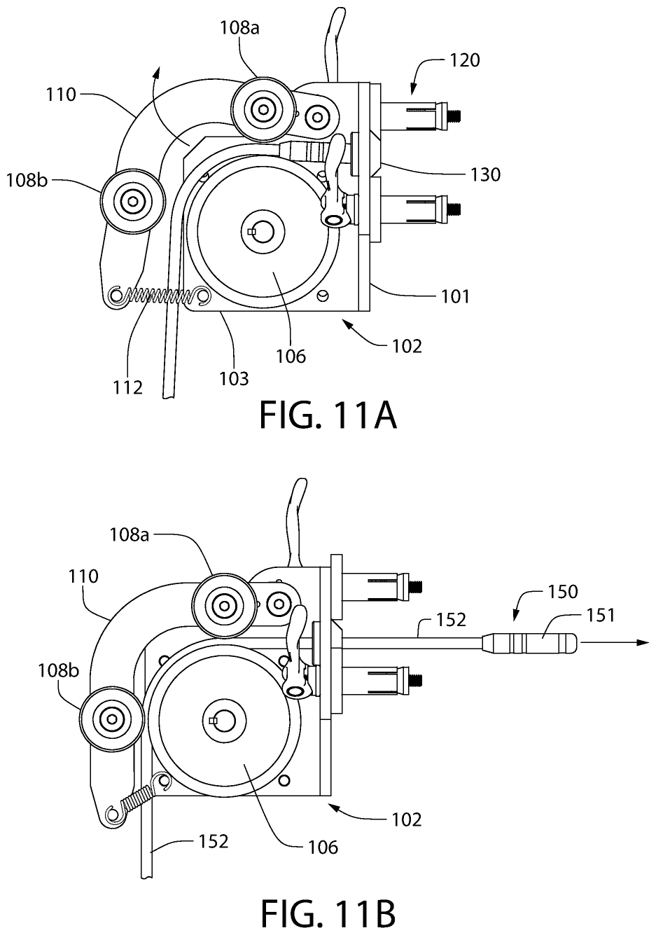

Pivot arm 110 is pivotably coupled to support bracket 102 via pivot pin 110a which defines a pivot axis PA of the arm. Pivot arm 110 may have an L-shaped body in one embodiment. Pivot pin 110a is coupled through the arm to the bracket 102 at a top end 111a of the arm. The opposite bottom end 111b of the arm may be biased towards the bracket via a return spring 112 connected between the arm and bracket (see, e.g., FIGS. 11A-B). Spring 112 may be a helical tension spring (also referred to as an extension spring) in one embodiment; however, other suitable type springs including torsion springs or others may be used so long as the pivot arm is biased towards the drive pulley of the eddy current testing apparatus.

The pivot arm includes at least one idler pulley 108 which engages and presses the test cable 152 into contact with the drive pulley 106 to maintain positive engagement therebetween. In a preferred but non-limiting embodiment, two idler pulleys 108a, 108b are provided which creates two spaced apart points of contact with the test cable 152 in order to maintain about 90 degrees of contact between the drive pulley 106 and test cable (+/−5 degrees). One top idler pulley 108b is positioned on pivot arm 110 above the drive pulley 106 which keeps the cable 152 engaged with the top of the drive pulley, and the other side idler pulley 108a may be positioned on the pivot arm to one side of the drive pulley (90 degrees apart from the top idler pulley) which keeps the cable engaged with one side of the drive pulley. This two idler pulley arrangement advantageously ensures more positive and smooth feeding and retraction of the test cable when the motor is operated attributed to 90 degree contact between test cable 152 and drive pulley 106. The L-shaped body of the pivot arm enables the mounting of one idler pulley 108b above drive pulley 106, and the other idler pulley 108b on one side of the drive pulley to achieve the 90 degree engagement between the drive pulley and test cable. Each idler pulley is rotatably coupled to pivot arm 110 via a cross pin 109 and freely rotates 360 degrees when the test cable is fed into or withdrawn from the heat exchanger tube under test. The center of top idler pulley 108b may intersect vertical axis VA and center of side idler pulley 108a may intersect horizontal axis HA in one embodiment; the axes which in turn each intersects the drive pulley 106. In other arrangements, one or both of the idler pulleys may not lie on the vertical and/or horizontal axes.

Pivot arm 110 is pivotably movable about the pivot axis PA to enable the eddy current test head 151 and attached test cable 152 to be easily threaded manually between the idler pulleys 108a, 108b and drive pulley 106 by the operator for initial setup of the eddy current testing apparatus 100. The pivot arm is movable between an inward engaged position in which the idler pulleys 108a, 108b (or single idler pulley if only one provided) presses the test cable 152 of the test probe 150 against the drive pulley 106 (see, e.g., FIG. 11B), and an outward disengaged position which releases the cable from the drive pulley (see, e.g., FIG. 11A). Both idler pulleys are disengaged from test cable 152 when the pivot arm is in the outward disengaged position as shown in FIG. 11A. A lower portion of the pivot arm 110 adjacent to its bottom end 111b defines a convenient handle portion 113 which can be readily grasped by the eddy current test operator to manually move the arm between its two foregoing positions. To provide maximum leverage for opening the pivot arm against the biasing action of return spring 112 and maximum displacement of the arm, the top end 111a of the arm is pinned to support bracket 102 via pivot pin 110a as shown. This advantageously provides the longest lever arm and displacement possible.

Face plate 101 of the support bracket 102 includes a test probe feed opening 131 which is configured (e.g., dimension and shape) to allow the test head 151 and attached test cable 152 to be slideably passed through the opening and face plate from the drive pulley 106 for insertion into the heat exchanger tubes 206 of the tubesheet 204 to be tested. In one embodiment, a replaceable alignment ferrule 130 is provided which is removably coupled to the face plate through the test probe feed opening. Alignment ferrule 130 comprises a central through passage 132 concentric with the test probe feed opening 131. The through passage 132 is sized larger than the largest outside diameter of the eddy current test head 151 and cable 152 so that they may both be inserted completely through the through passage of the alignment ferrule and into the heat exchanger tube to be tested in the tubesheet 204 of the heat exchanger 200, as further described herein.

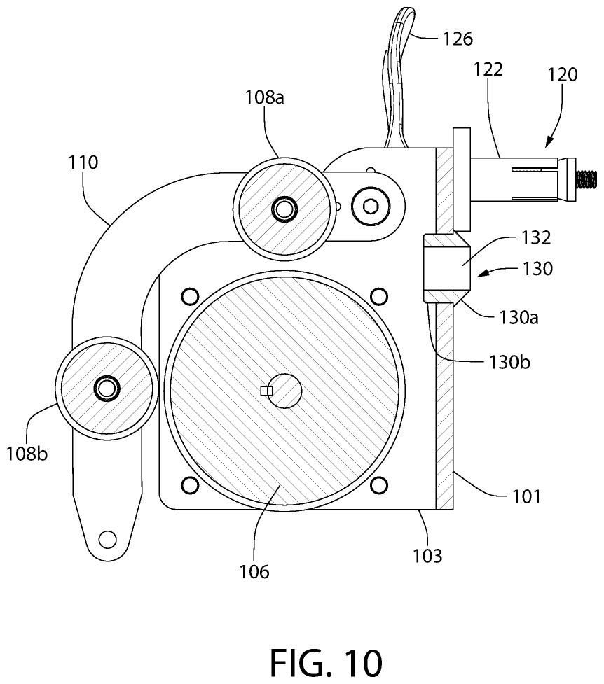

In one embodiment, alignment ferrule 130 has an annular body including a frustoconical-shaped front portion 130a located on the front major surface 101a of the face plate 101 which faces the heat exchanger tubesheet when the eddy current testing apparatus 100 is in use, and a rear cylindrical-shaped rear portion 130b on the opposite rear major surface 101b of the face plate. The ferrule 130 may have a one-piece monolithic body in one embodiment as shown (see, e.g., FIGS. 1 and 10 in particular). Rear portion 130b is inserted into and seated in test probe feed opening 131 in face plate 101 of the support bracket 102. Front portion 130a defines an annular lip 133 having a diameter larger than test probe feed opening 131 in face plate 101 of the support bracket 102 for abutment and seating against the front major surface of the face plate. The frustoconical shaped walls of alignment ferrule 130 converge moving forward from face plate 101 and are partially insertable into and engageable with open ends 206a of the heat exchanger tube 206 under test at the tubesheet 204. The ferrule 130, and particularly the frustoconical shaped wall are operable to advantageously help the test equipment operator/technician guide and center the ferrule in the heat exchanger tube opening of the tube under test in the tubesheet being tested in a controlled manner, and in turn centers the eddy current test head 151 and cable 151 in the tested tube. Because the broadened vertical face plate 101 of the apparatus support bracket 102 may visually obscure the heat exchanger tube in the tubesheet 204 under test at least partially, this is a significant operator aid to help readily align the apparatus and test probe with the tube for testing. The alignment ferrule may be made of any suitable metallic material or non-metallic material (e.g., plastic).

Alignment ferrule 130 is replaceable so as to be interchangeable with other ferrules having different diameter through passages 132 to accommodate eddy current test heads 151 and associated cables 152 of differing diameters. The cylindrical test heads may have different diameters for use with heat exchanger tubes having different internal diameters. This advantageously allows the same support bracket 102 and appurtenances coupled thereto described herein to be reused for testing heat exchanger tubes of different heat exchangers having different size tube diameters. A plurality of alignment ferrules may be therefore be provided which differ in the diameter of the through passages 132 alone, but otherwise may have the same general configuration and features such as the frustoconical shape. In addition, the test equipment operator may carry several size alignment ferrules in the field with the eddy current testing apparatus thereby allowing the ferrules to be readily swapped out as needed at the testing site for different heat exchangers with different size tubes.

Eddy current testing apparatus 100 includes a plurality of tube clamps 120 configured for detachably coupling the apparatus to tubesheet. Tube clamps 120 are configured and operable for securement to heat exchanger tubes of the heat exchanger which are not presently being tested for defects. Tube clamps 120 in turn may be detachably coupled to the face plate 101 of bracket 102 in one embodiment, as further described herein.

A plurality of radially expandable tube clamps 120 may be provided which are configured to detachably couple the eddy current testing apparatus 100 to the heat exchanger tubesheet accessed for testing the heat exchanger tubes coupled thereto. Tube clamps 120 in one embodiment may each be detachably coupled to face plate 101 of the apparatus support bracket 102 via an adjustment slot 121 in the face plate. This allows the position of the tube clamps to be adjusted to match the pitch of available heat exchanger tubes 206 in the tubesheet 204 into which locking portions of the clamps are inserted for detachably coupling thereto. In one embodiment, adjustment slots 121 may each be oriented at an oblique angle to the horizontal axis HA and vertical axis VA of the apparatus 100. This provides both horizontal and vertical adjustment of the tube clamps with respect to the heat exchanger tubes 206.

In one embodiment, at least two tube clamps 120 are provided; preferably one located on each side of probe test head and cable feed opening 131 in face plate 101 (and alignment ferrule 130). This couples the testing apparatus support bracket 102 to the heat exchanger tubesheet 204 in a stable and cantilevered manner. In some embodiments, three or more adjustment slots may be provided in the bracket face plate 101 which helps to ensure that at least two heat exchanger tubes 206 are alignable with the tube clamp locations on the face plate. Three or more tube clamps may be used in some embodiments if needed for stable support to the testing apparatus.

In one embodiment, tube clamps 120 each comprise a tubular securement sleeve 122 including an expandable end 127 comprising circumferentially spaced apart axial slots 123. The slots allow the sleeve material to expand radially outwards when deformed by an inside-to-outside radially-acting expansion force. Slots 123 are elongated in the direction of and extend partially along the length of the sleeve sufficient to securely grip the inside surface of the anchoring tube of the heat exchanger tubes in which the tube clamp is to be anchored. Slots 123 are arranged parallel to each other to define resiliently deformable fingers between the slots which are deformable and deflectable in an outward direction to frictionally grip the heat exchanger tube when spread apart by the expansion plug 125 as described elsewhere herein. For this purpose, securement sleeve 122 may be formed of a suitable metallic material and has a wall thickness selected to form a resiliently deformable expandable end 127 of the sleeve. In other embodiments, the securement sleeve may be formed of plastic.

In one embodiment, the securement sleeve 122 may be disposed on the front major surface 101a side of the face plate 101 which faces the heat exchanger tubesheet 204 when the testing apparatus 100 is in use. The sleeve has a length sufficient to securely engage the interior surface of the heat exchanger tube 206 to which the tube clamp will be temporarily coupled and anchored. Securement sleeve 122 has a mounting end 138 (opposite expandable end 127) which may terminate near the front major surface of the face plate 101. The securement sleeve projects perpendicularly outwards from front major surface 101a of the face plate towards the heat exchanger tubesheet for insertion into an anchoring tube in the tubesheet 204. An annular base collar 139 may be provided which abuts face plate 101 and surrounds mounting end 138 of the securement sleeve on the front major surface 101a of the face plate. The collar has a circular receptacle 139b which receives the mounting end 138 of securement sleeve 122 therein to provide lateral support to the sleeve to resist twisting and maintain the perpendicularity of the sleeve with respect to the face plate particularly when actuating lever 126 is rotated to its locked position which draws the expansion plug 125 rearward against the securement sleeve. The base collar 139 further comprises a through hole 139a through which the operating rod 122 passes for connection to the expansion plug. Collar 139 may be releasably and loosely positioned on face plate 101 of the apparatus support bracket 102; the collar being held in place by the securement sleeve 122, operating rod 124, and expansion plug 125 of the tube clamp assembly (further described herein) which compresses the parts together. In other embodiments, the collar may be fixedly coupled to the face plate if formed of metal and optionally the securement sleeve such as via welding if rigid permanent attachment is desired.

As noted above, tube clamp 120 further includes a linearly movable operating rod 124 extending through the securement sleeve, and expansion plug 125 coupled proximate to one end of the operating rod. Operating rod 124 extends completely through face plate 101 having a front portion 124a which projects outwards from securement sleeve 122 on the front side of the face plate, and a rear portion 124b which projects outwards from the securement sleeve on the rear side of the face plate.

Expansion plug 125 includes a threaded through passage 125c for receiving and threadably coupling the threaded front portion 124a of operating rod 124 thereto. The expansion plug is positioned on the operating rod adjacent to and engageable with the slot-containing expandable end 124 of the securement sleeve 122.

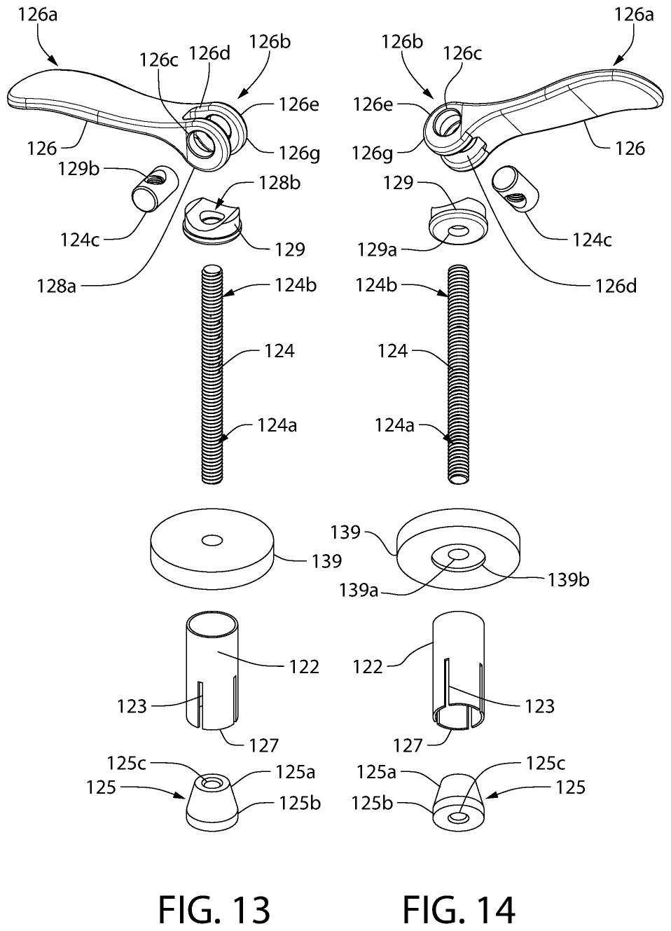

Expansion plug 125 is has a tapered configuration operable to engage and spread the slotted expandable end of each securement sleeve 122 radially outwards to frictionally engage and grip the inside surfaces of the heat exchanger anchoring tube 206 to which the tube clamp 120 is detachably coupled to support the apparatus 100 for eddy current testing. The expansion plug has a substantially frustoconical shape for a majority of its length and is at least partially insertable inside the expandable end 127 of the securement sleeve 122 (see, e.g., FIGS. 13-16). The expansion plug 125 includes inner portion 125a having a diameter smaller than the inside diameter of the expandable end 127 of the securement sleeve 122, and an outer portion 125b having a diameter larger than the inside diameter of the sleeve expandable end. The tapered walls of the expansion plug gradually diverge outwards away from operating rod 122 moving from the inner portion to outer portion of the plug. When the operating rod 124 is retracted inwards into the securement sleeve 122 via rotation of the actuating lever 126, the outer portion 125b acts on the slotted expandable end 127 to radially force and expand the end outwards to frictionally engage the inside surface of the heat exchanger tubes 206 to which to which the tube clamp is to be anchored. The expandable end 127 assumes an outwardly splayed or flared configuration when radially enlarged.

To actuate and linearly move the operating rod 124, tube clamps 120 each comprise a manually-operated actuating lever 126 pivotably coupled to the rear end 124b of the operating rod. The lever 126 is operable to linearly move the operating rod forward and rearward through the securement sleeve 122 in selected opposing directions. Actuating lever 126 has an elongated structure to facilitate easy grasping and manual operation by the test equipment operator. Lever 126 includes a grasping end portion 126a and opposite camming end portion 126b disposed adjacent to rear end 124b of operating rod 124 which actuates and linearly moves the rod when the lever is operated.

To translate pivotably movement of actuating lever 126 into linear movement of the operating rod 124 inside securement sleeve 122 and radially spread/enlarge the sleeve's slotted expandable end 127 for gripping the heat exchanger anchoring tubes, camming end portion 126b of the lever includes an arcuately curved cam surface 128a which is selectively engageable with a flat bearing surface 128b disposed at the rear portion 124b of the operating rod. In one embodiment, the bearing surface 128b may be defined by a cam washer 129 having an opening 129a through which the rear portion of the operating rod 124 passes at the rear major surface 101b of face plate 101. Bearing surface 128b may be arcuately curved and complementary configured to the arcuately curved camming end portion 126b of actuating lever 126.

In one embodiment, operating rod 124 may be partially or fully threaded rod coupled to camming end portion 126b of the actuating lever 126. If partially threaded, at least the front portion 124a and rear portion 124b of the rod may be threaded to engage the expansion plug 125 and cam washer 129, respectively (the central portion being unthreaded).

The actuating lever camming end portion 126b defines an enlarged cam head 126e at one end of the lever. Cam head 126e may have a generally circular but uneven oblong or lobe shape whose outer circumferentially-extending arcuately curved surface has portions/sections which define both a cam surface 128a and release surface 128c. Both the cam and release surfaces may therefore be arcuately curved. Cam surface 128a may contiguous to release surface 128c being located adjacent to and adjoining one end of the release surface. The cam surface extends for an arc length which is smaller than the arc length of the release surface 128c such that the release surface occupies a larger region of the circumference of the cam head 126e. Cam surface 128a is located radially farthest from pivot pin 124c than the release surface 128c for purposes which will become evident explained below. A gradual reduction in the distance from the pivot pin 124c to the outer surface of the cam head 126 may be provided; the cam surface being radially farthest from the pivot pin and the release surface being radially closest.

The cam head 126e of actuating lever 126 may be a bifurcated structure forming two spaced apart halves 126g defining a slot 126d therebetween and holes 126c in each half. Each half 126g comprises a portion of cam surface 128ab and release surface 128c. Slot 126d receives pivot pin 124c which in turn threadably engages the rear portion 124b of the operating rod 124 engaged with threaded through hole 129b in the pin. The holes 126c in each half 126g are concentrically aligned to receive pivot pin 124c which pivotably couples the operating rod to actuating lever.

Actuating lever 126 of each tube clamp 120 is pivotably movable between (i) a locked position which draws the operating rod 124 and expansion plug 125 rearwards towards the actuating lever and inwards into the front expandable end 127 of securement sleeve 122 to in turn spread the expandable end radially outwards (i.e. radially enlarge the expandable end) to frictionally engage the inside surface of one of the heat exchanger tubes 206 in which the tube clamp is to be anchored, and (ii) an unlocked position which projects the operating rod and expansion plug thereon away from the actuating lever and outwards from the expandable end of the securement sleeve to allow the expandable end to collapse radially inward to unlock the tube clamp from the heat exchanger tube for withdrawing the tube clamp therefrom.

In the locked position of actuating lever 126, the tapered expansion plug 125 slideably and fully engages and forces the expandable end 127 of securement sleeve 122 radially outwards. In the unlocked position, the expansion plug 125 is partially retracted from the securement sleeve to disengage the expandable end of the sleeve sufficiently so that the expandable end is no longer forced and held outwards to be free to collapse radially inwards when the test equipment operator manually withdraws the tube clamps 120 from the heat exchanger tubes 206 in which they were anchored.

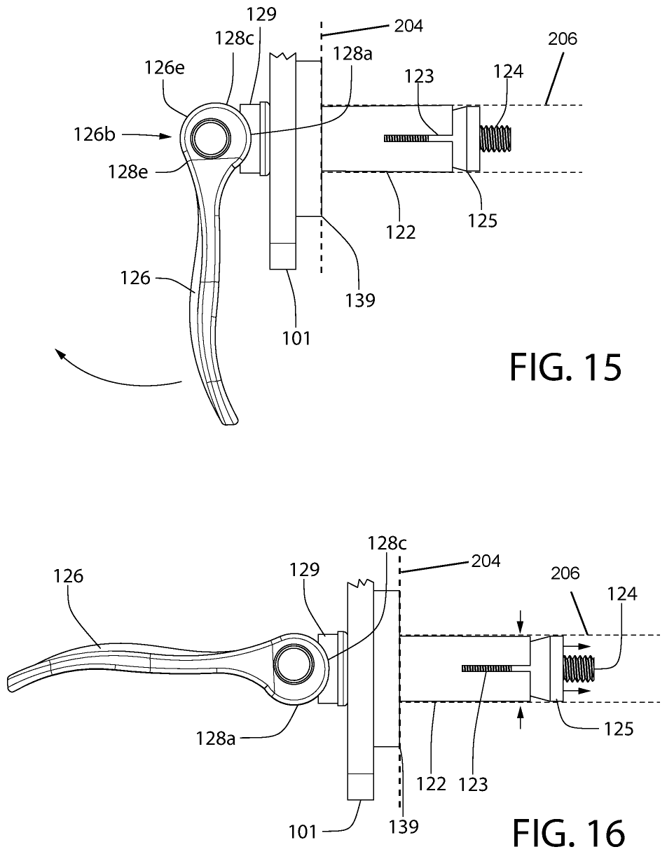

Rotating the actuating lever 126 to the locked position from the unlocked position slideably and fully engages the curved cam surface 128a with the curved bearing surface 128b on cam washer 129 (see, e.g., FIG. 15 showing the locked position). Because the cam surface is spaced farther from pivot pin 124c than any portions of the release surface 128c as previously noted, engagement between the cam surface and bearing surface generates a linearly-acting force on the operating rod 124 which pries and pulls the rod rearwards via a camming action of the lever. The actuating lever is now in a tightened condition which linearly displaces the operating rod. The actuating lever 126 may be approximately vertical (when the testing apparatus 100 is in the usual upright vertical position shown in FIG. 1). The grasping end portion 126a of the lever as shown is positioned proximate to the face plate 101 of the apparatus bracket 102.

Returning the actuating lever 126 to the unlocked position loosens the actuating lever and releases engagement between the cam surface 128a of lever 126 and bearing surface 128b on cam washer 129. Because the release surface 128c is closer to pivot pin 124c of the lever as previously noted, engagement between the release surface and bearing surface 128b results in a loosened condition of the actuating lever which generates no linear tensile force on the operating rod to draw the rod and expansion plug into the securement sleeve. Disengaging cam surface 128a from bearing surface 128b immediately results in some degree of loosening of the tube clamp 120. This may be sufficient in some cases to disengaged the expandable end 127 of securement sleeve 122 from the anchoring tube to allow the tube clamp to be withdrawn. Continuing to rotate the actuating lever in which the bearing surface 128b slideably engages the release surface 128c of the lever cam head 126e more and more results in further loosening of the engagement. The actuating lever 126 may be approximately horizontal for full release and loosening of the lever so that the slotted expandable end 127 of securement sleeve 122 can be radially collapsed to the maximum degree (see, e.g., FIG. 16). However, as noted above, simply disengaging the cam surface 128a from the bearing surface 128c begins to loosen the lever such that the lever is in a loosened condition when the cam surface is disengaged; the degree of looseness gradually increasing as the lever is continued to be rotated towards a horizontal orientation.

A method or process for coupling and using the eddy current testing apparatus 100 to test heat exchanger tubes for defects will now be briefly described. The tube clamps 120 of the apparatus may each be initially set up by inserting the operating rod 124 already pinned to actuating lever 126 through a selected adjustment slot 121 from the rear through the front of the apparatus face plate 101. On the front side of the face plate, the operating rod is passed through the base collar 139 and securement sleeve 122 until the threaded front portion 124a of the rod projects outwards from the expandable end 127 of the sleeve. Next, the process involves threading expansion plug 125 onto the exposed front end portion of the operating rod 124 until the smaller diameter inner portion 125a of the tapered plug is partially inserted into expandable end 127 of securement sleeve 122 (see, e.g., FIG. 16). The actuating lever 126 is in the unlocked position during this setup process as shown (i.e. release surface 128b engaged with curved bearing surface 128b on cam washer 129). The testing apparatus is now ready to be detachably anchored and mounted to the tubesheet of the heat exchanger for conducting eddy current testing of the tubes for defects. The actuating lever may remain unlocked at the start of the following steps to facilitate adjustment and mounting the apparatus to the tubesheet as described below.

Preferably, at least two tube clamps 120 may be provided for secure anchorage of the apparatus to the tubes in a cantilevered manner. This arrangement provides stable securement under most any circumstances which resists twisting due to the weight of the apparatus and operation of the motor for feeding the test probe into the heat exchanger tube 206 under test in the tubesheet 204. Preferably, one tube clamp on each side of alignment ferrule 130 is used where possible. Additional tube clamps 120 may be used if needed in certain circumstances for a stable mount.

To mount the eddy current testing apparatus 100 to the heat exchanger tubesheet 204, the support bracket 101 of the testing apparatus 100 is next moved towards and positioned adjacent to tubesheet 204. Each tube clamp 120 provided is aligned with one of the tubes 206 in the tubesheet not presently under test for anchoring, and then inserted therein while the actuating lever remains in the unlocked position so that the tube clamp is in the loosened state. This allows the tube clamp to be readily adjusted relative to face plate 101 via the adjustment slots 121 therein as previously described to guide the clamp into the selected heat exchanger tube to which it is to be anchored. Such tubes may be referred to herein as “anchoring” tubes for brevity, which are distinct from the tube under test to be inspected via the eddy current testing apparatus 100.

The step of inserting the tube clamps 120 into the anchoring heat exchanger tubes concurrently partially inserts and engages the tapered alignment ferrule 130 on the apparatus face plate 101 with the selected heat exchanger tube under test. The frustoconical portion which defines tapered walls of the alignment ferrule engage the heat exchanger tube. Once the test equipment operator or technician is satisfied that the testing apparatus is properly aligned and positioned, the actuating levers 126 may be manually rotated to their locked positions (see, e.g., FIG. 15). This engages the cam surface 128a on cam head 126e of each actuating lever provided with its mating bearing surface 128b on cam washer 129 to create a tightened condition of the tube clamps. Engagement between the cam surface and bearing surface draws and retracts the operating rod 124 rearward farther into the securement sleeve 122 (as previously described) while concurrently drawing the larger diameter outer portion 125b of expansion plug 125 into engagement with slotted expandable end 127 of securement sleeve 122. The plug radially expands the expandable end which frictionally engages the inside surfaces of the selected anchoring tubes to lock the tube clamps 120 to the tubes. The testing apparatus is now detachably supported in a cantilevered manner from the heat exchanger tubesheet 204.

The test probe 150 comprised of testing head 151 and attached testing cable 152 may next be manually installed in the eddy current testing apparatus 100 and inserted into the tube under test. This process is simplified and convenient for the test equipment operating by using the spring-biased pivot arm 110. With the apparatus anchored to and supported from the heat exchanger tubesheet 204, the pivot arm is opened and manually rotated to its outward disengaged position (against the biasing force of return spring 112) so that the idler pulleys 108a, 108b are distally located relative to the drive pulley 106 (see, e.g., FIG. 11A). In FIG. 11A, this is an upward movement of the pivot arm. This provides sufficient clearance to now allow the test head and cable to be readily threaded between the drive pulley 106 and idler pulleys 108, and then inserted through the through passage 132 in alignment ferrule 130 from the rear side of face plate 101 and into the heat exchanger tube under test already engaged by the ferrule, as previously described herein. The cable may be looped over and engaged with the drive pulley 106 as shown.

The operator may then release the pivot arm 110 thereby allowing the return spring 112 to automatically pull the pivot arm 110 back to its original inward engaged position (this is a downward movement of the pivot arm in FIG. 11B). With this closing action of the pivot arm, the idler pulleys 108a, 108b press the test cable 152 of the test probe 150 against the drive pulley 106 (see, e.g., FIG. 11B). The cable is trapped between the drive pulley and idler pulleys but rotatable therebetween via operation of the motor 104 to rotate drive pulley 106 in the manner previously described herein. The testing apparatus 100 is now ready for performing eddy current of the tube under test.

The controller 250 may automatically conduct the heat exchanger tube examination process by gradually feeding and advancing the test probe head 151 and cable 152 through the inside of the tube under, while receiving test data signals from the test head to detect any tube defects.

Once the testing is complete, the foregoing process is reversed to first withdraw the test head 151 and cable 152 of test probe 150 from the tube under test via moving pivot arm 110 back to its outward position which release the cable. Next, the testing apparatus 100 is dismounted from the tubesheet via reversing the process previously described herein for installing the tube clamps 120 into the anchoring tubes. Actuating levers 126 are each moved to their unlocked positions to loosen the tube clamp assemblies, allowing the slotted expandable ends 127 of the securement sleeves 122 to collapse radially inward so that the test equipment operator can simply pull rearward on the apparatus support bracket 102 to remove the tube clamps from the anchoring tubes. The testing apparatus may then be relocated and coupled to the tubesheet 204 again at a different location for the next tube to be tested. It bears noting that several eddy current testing apparatuses may be installed on the tubesheet at the same time to allow concurrent testing of several heat exchanger tubes at once.

Once one or more testing apparatuses 100 are setup for testing and coupled to the heat exchanger tubesheet 204 as described above, the eddy current testing of all tubes may be controlled automatically via a programmable controller 250.

Multiple Testing Unit System

When an inspection of a heat exchanger is being performed during an outage at a power generation plant, time is of the essence. A short window of time is allowed for equipment maintenance and inspection since every day the generation unit cannot be returned to service to produce power can cost tens of thousands of dollars in lost generation and revenue. The concept of the multiple eddy current inspection system disclosed herein using several eddy current testing apparatuses 100 simultaneously in conjunction with controller 250 advantageously leverages the inspector's time by allowing testing of multiple tubes at once. The eddy current testing apparatuses can each be operably coupled and communicably linked to the controller 250 via wireless or wired communication links to control and coordinate the testing of the multiple tubes at once. Test data is transmitted from each testing apparatus back to the controller and recorded for analysis.

Each eddy current testing apparatus 100 can be quickly manually clamped to the heat exchanger tubesheet 204 by expanding the tube clamps 120 in the bores (interior) of the anchor tubes proximate to tubes to be inspected, as previously described herein. Once installed, the eddy current probe cable of each testing apparatus would be driven at a controlled speed and the probe's location in the tube would be measured by the self-contained drive motor-encoder assembly. Location and tube condition would be data logged into the controller 250 for each testing apparatus in operation. The test equipment operator or technician could run one, two, three, four, or more test units simultaneously as an example if ample room is present. Time savings would be commensurate with the number of units operating. It is conceivable that 3,000 tubes could be inspected by a proficient inspection team in an 8 hour shift.

Numerous advantages can be attributed to the eddy current testing apparatus 100 disclosed herein. Some of these include the ability to feed the test probe head and cable through the support bracket 102 and into the heat exchanger tube under test after the testing apparatus is mounted to the tubesheet via rotating the pivot arm 110 to its outward disengaged position. The added clearance provided by the pivot arm makes it easy for the test equipment operator to feed the test head 151 and cable 152 of the test probe 150 through the assembly of pulleys 106, 108a, and 108b of the apparatus and into the heat exchanger tube under test. Releasing the pivot arm allows the return spring 112 to automatically rotate the arm back inwards so that the idler pulleys 108a, 108b press the test cable tightly against the drive pulley 106 for positive feeding of the test cable to conduct the eddy current testing. It bears noting that spring 112 advantageously acts to maintain a constant pressure on the cable by biasing the pivot arm 110 inwards.

The manually-operated actuating levers 126 of the tube clamps 120 allow the testing apparatus to be easily and securely mounted to and removed from the tubesheet for setup and takedown. The entire tube clamp assembles remain attached to support bracket of the apparatus so that the test equipment operator need not handle any loose parts which can be lost when moving the testing apparatus 100 from one tube under test to the next. The apparatus is further compact and portable making it readily transportable with the attached drive motor. The small profile of the apparatus allows a maximum number of multiple eddy current testing apparatuses to be operated simultaneously on the heat exchanger tubesheet 204 to test a group of tubes in parallel, thereby reducing the time to test all tubes in the heat exchanger. Other advantages are described elsewhere herein.

While the foregoing description and drawings represent some example systems, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

1. An eddy current testing apparatus comprising:
a bracket configured for detachable coupling to a tubesheet of a heat exchanger;
a rotatable drive pulley operably coupled to a motor supported by the bracket;
a pivot arm coupled to the bracket and pivotably movable about a pivot axis, the idler pulley comprising a first idler pulley;
an eddy current test probe comprising a test head and cable, the cable routed between and engageable with the first idler pulley and the drive pulley;
the first idler pulley operable to press the test cable against the drive pulley to maintain engagement therebetween;
wherein rotating the drive pulley in a first rotational direction feeds out cable from the apparatus, and rotating the drive pulley in a second rotational direction retracts cable back to the apparatus.

2. The apparatus according to claim 1, wherein the bracket comprises a face plate defining a test probe feed opening which slideably receives the test head and cable therethrough from the drive pulley for insertion into a first tube under test of the tubesheet.

3. The apparatus according to claim 2, further comprising a replaceable alignment ferrule removably coupled to the face plate through the test probe feed opening, the alignment ferrule being engageable with the first tube when the face plate is positioned proximate to the tubesheet.

4. The apparatus according to claim 3, wherein the alignment ferrule has an annular body comprising a central passage which defines the probe feed opening which is sized to pass the test head and cable therethrough.

5. The apparatus according to claim 4, wherein the alignment ferrule has a two-piece structure comprising a rear piece coupled to a front piece through the test probe feed opening in the face plate.

6. The apparatus according to claim 3, wherein the alignment ferrule comprises a tapered frustoconical portion which is partially insertable into and engageable with an open end of the first tube in the tubesheet to center the test head in the first tube.

7. The apparatus according to claim 2, further comprising a pair of tube clamps detachably coupled to the face plate, the tube clamps including a tubular securement sleeve including a radially expandable portion insertable into a respective second heat exchanger tube and a third heat exchanger tube in the tubesheet for anchoring the bracket thereto.

8. The apparatus according to claim 7, wherein each securement sleeve includes a radially expandable end operable to frictionally engage inside surfaces of the second or third heat exchanger tubes to secure the bracket thereto.

9. The apparatus according to claim 8, wherein the expandable ends of each securement sleeve comprises a plurality of circumferentially spaced apart slots orientated along a length the securement sleeve.

10. The apparatus according to claim 8, wherein each tube clamp includes an operating rod extending through the securement sleeve, and an expansion plug coupled proximate to a first end of the operating rod and engageable with the expandable end of the securement sleeve, the expansion plug being configured to radially spread the expandable ends of each securement sleeve radially outwards to frictionally engage the inside surfaces of the second or third heat exchanger tubes.

11. The apparatus according to claim 10, wherein the expansion plug includes an inner portion inserted inside the expandable end of the securement sleeve, and a diametrically enlarged outer portion disposed outside the expandable end including an outside diameter larger than an inside diameter of the expandable end.

12. The apparatus according to claim 11, wherein the tube clamps each comprise a manually-operated actuating lever pivotably coupled to a second end of the operating rod.

13. The apparatus according to claim 12, wherein the actuating lever of each tube clamp is pivotably movable between: (i) a locked position which draws the operating rod and expansion plug towards the actuating lever and into the securement sleeve to spread the expandable end of the securement sleeve radially outwards to frictionally lock the tube clamp to the second or third heat exchanger tubes; and (ii) an unlocked position which projects the operating rod and expansion plug away from the actuating lever and the expandable end of the securement sleeve to allow the expandable end to collapse radially inward to unlock the tube clamp from the second or third heat exchanger tubes.

14. The apparatus according to claim 10, wherein the tube clamps support the bracket from the tubesheet in a cantilevered manner when the actuating levers are in the locked position.

15. The apparatus according to claim 14, wherein each operating rod extends through an elongated adjustment slot in the face plate which allows tube clamp to be adjusted in position relative to the face plate.

16. The apparatus according to claim 1, wherein the pivot arm is movable between an inward engaged position in which the first idler pulley presses the test cable of the test probe against the drive pulley, and an outward disengaged position which releases the test cable from the drive pulley.

17. The apparatus according to claim 16, further comprising a return spring which biases the pivot arm towards the inward engaged position.

18. The apparatus according to claim 1, further comprising a second idler pulley rotatably coupled to the pivot arm, the second idler pulley arranged and operable to press the test cable of the test probe against the drive pulley at a different location than the first pulley.

19. The apparatus according to claim 18, wherein the first and second idler pulleys are operable to maintain about 90 degrees of contact between the drive pulley and the cable

20. The apparatus according to claim 19, wherein the second idler pulley is disposed on top of the drive pulley and the first idler pulley is disposed on one side of the drive pulley.

21. The apparatus according to claim 18, wherein the drive pulley and the first and second idler pulleys are: (a) oriented inline and parallel to each other, and (b) oriented perpendicular to the face plate which is parallel to the tubesheet when the bracket is coupled to the tubesheet.

22. The apparatus according to claim 18, wherein the pivot arm has an L-shape.

23. The apparatus according to claim 1, wherein a first end of the pivot arm is coupled to the bracket via a pivot pin which defines the pivot axis, and a second end of the pivot arm is not coupled to the bracket to define a handle for manually moving the pivot arm about the pivot axis between the inward engaged position and the outward disengaged position.

24. The according to claim 1, further comprising a programmable controller operably coupled to the motor and test probe, the controller operable to rotate the drive pulley in the first and second rotational directions via the motor.

25-40. (canceled)
